(19) United States
(12) Patent Application Publication
(10) Pub. No.: US 2005/0086598 A1
(43) Pub. Date: Apr. 21, 2005

(54) Document digest system and methodology

(76) Inventors: John L. Marshall III, Jacksonville, FL (US); Raymond E. Gianni, Jacksonville, FL (US); John G. Yarbrough, Jacksonville, FL (US); Laurie Chamberlin, Washington, DC (US)

Correspondence Address: Mark J. Young;McGuire Woods LLP, Suite 3300, 50 North Laura Street, Jacksonville, FL, 32202, US

(21) Appl. No.: 10/691,926

(22) Filed: Oct. 21, 2003

(51) Int. Cl. G06F 15/00; G06F 17/21

(52) U.S. Cl. 715/530

(57) ABSTRACT

A multi-user system and method for managing the summarizing of documents provides a structured framework for receiving and uploading documents, making and managing assignment, monitoring the status of summaries, performing quality control, and distributing summaries. Templates facilitate preparation of summaries in acceptable consistent formats.

### BACKGROUND OF THE INVENTION

1. Field of the Invention

This invention generally relates to systems and methods for summarizing documents, and more particularly, to systems and methods for providing a structured framework for summarizing complex documents, reviewing summarized documents for quality control and managing summarization efforts.

2. Background Description

The management and review of massive volumes of documents often requires summarization. Efficiently completing the summaries may require participation from various individuals, each having distinct roles and skill sets. For example, a document may be supplied by a client to a manager. The manager may then convert the document to a desired format, submit the converted document to a consultant for preparation of the summary, advise the consultant of applicable deadlines and other pertinent information, and monitor the consultant's progress to ensure timely completion. The consultant may then review and summarize the document according to established standards and formats, over a period of time, reporting his or her progress to the manager or someone else periodically. Upon completion of the summary, the consultant may submit it to the manager or someone else for review and approval. If the reviewer finds the summary acceptable, the reviewer may submit it to the client. If changes are necessary, the reviewer may either edit the summary or reassign it to the original consultant (or another consultant) for editing.

The overall process is quite involved, conducive to error and oversight. An assignment or a deadline may be overlooked. An incorrect format may be used for the summary. Various errors may be overlooked if the summary is not carefully reviewed.

Unfortunately, document management systems known in the art do not facilitate performance of the foregoing tasks. Conventional document management systems may allow a user to associate identifying and limited descriptive data with a document and save it. A search may be performed to retrieve the document. More elaborate systems may enable tagging text of interest. While useful for archiving documents, such systems fall short of the assignment, review, monitoring and distribution capabilities needed to efficiently manage the document summarization process.

The invention is directed to overcoming one or more of the problems as set forth above.

### SUMMARY OF THE INVENTION

In one aspect of the invention, a comnputer implemented document digest system is provided. The system includes a module configured to enable a user to assign a document to a consultant for creating a digest. Another module is configured to enable the consultant to access, create and edit the digest. A third module enables a reviewer to review the digest created by the consultant.

In another aspect of the invention, a computer implemented document digest process is provided. The process entails assigning a document to a consultant for creating a digest and notifying the consultant of the assignment via network communications. The consultant may access, create and edit the digest for the document. Upon completion of a digest, a consultant may notify a reviewer. The reviewer may then review the digest created by the consultant for quality control.

### BRIEF DESCRIPTION OF THE DRAWINGS

The foregoing and other objects, aspects, and advantages will be better understood from the following detailed description of a preferred embodiment of the invention with reference to the drawings, in which:

FIG. 1 shows a high-level block diagram of a computing system for use in accordance with an exemplary implementation of the invention;

FIG. 2 shows a use case diagram conceptually allocating responsibilities to various types of users in accordance with an exemplary embodiment of the present invention;

FIG. 3 is a flow diagram illustrating steps of a methodology in accordance with an exemplary implementation of the invention;

FIG. 4 shows a document upload screen for a deposition in accordance with an exemplary embodiment of the invention;

FIG. 5 shows an assignment screen for a system in accordance with an exemplary embodiment of the invention; and

FIG. 6 shows a status screen for a system in accordance with an exemplary embodiment of the invention.

### DETAILED DESCRIPTION OF EMBODIMENTS OF THE INVENTION

The invention is directed to a system for managing the summarizing of documents, i.e., the creation of digests. In an exemplary implementation, the system provides a structured framework for receiving documents, making and managing assignments, monitoring the status of summaries, summarizing, quality control review of summaries and distributing completed summaries.

The scope of the invention is not limited to any particular type, content or format of document. The document to be summarized may be in print, electronic or other form, whether now known or hereafter developed. The document may be a legal document, such as a transcript of a deposition or trial testimony, a contract, or some other legal document. Other types of documents may include medical, financial, technical, or business documents, including proposals and bids, journal articles, computer programs, or any other subject matter that may be summarized. The document may contain text, equation, codes, graphics, photographs, or any other means of expression, depending upon the configuration of the system. For example, the system may be configured to receive only text. In such a case graphics may be omitted, or a reference or a URL for a file containing the graphics may be included in the text.

As used herein, summarization broadly refers to preparing a summary, abstract, paraphrase, digest, or any other brief, concise or clarified representation or description of a document or any portions thereof regardless of whether the resulting work is shorter or longer than the document being summarized. A summary may employ conventional text, symbols, charts, tables, pictures, graphics, abbreviations, codes or other information or means of expression. As used herein, the terms “summary” and “digest” are synonymous, and broadly refer to any product of summarization.

### System of the Invention

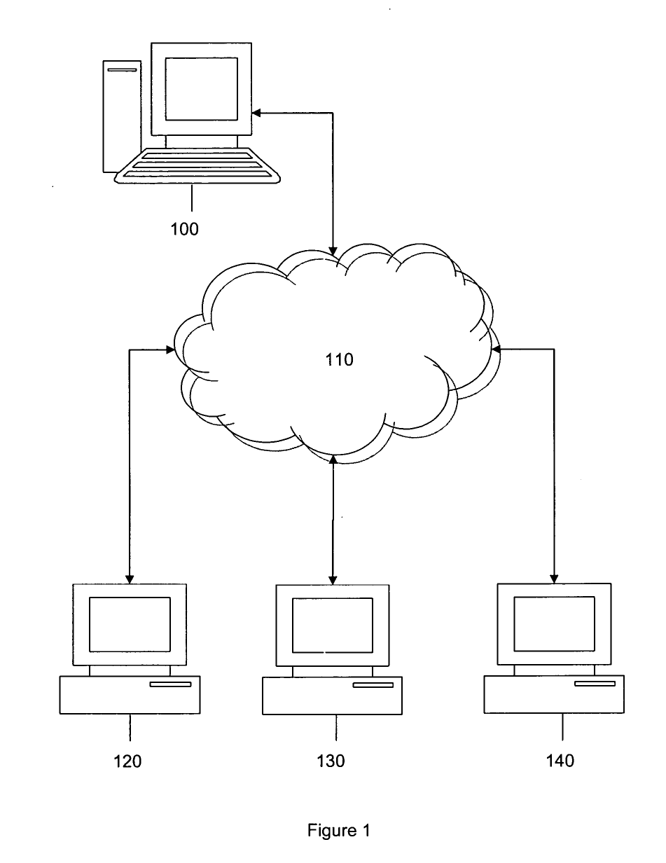

Referring to FIG. 1, an exemplary computing and network environment for implementing a system and methodology in accordance with the present invention is conceptually shown. Preferably, a client-server architecture is used, wherein a plurality of client computing devices 120, 130 and 140 are communicatively coupled to a server 100 via network communication means 110. By way of example and not limitation, three client computers are conceptually shown. Those skilled in the art will appreciate that other configurations with fewer or more computers may be used to implement a document digest system and methodology in accordance with the present invention.

In the exemplary configuration as conceptually shown in FIG. 1, each computing device 100 and 120-140 may, for example, be a conventional computer with a processing unit, a system memory and a system bus that communicatively couples various system components including the system memory to the processing unit. The system bus may be any of several types of bus structures using any of a variety of bus architectures. The system memory may include read only memory (ROM) and random access memory (RAM). A basic input/output system (BIOS), containing routines that help to transfer information between elements within the computer may be stored in ROM. The computer may also include storage devices such as a magnetic hard disk drive, a magnetic disk drive for reading from or writing to removable magnetic disk, and an optical disk drive for reading from or writing to a removable optical disk such as a CD-ROM or other optical media. The magnetic hard disk drive, magnetic disk drive, and optical disk drive may be connected to the system bus by a hard disk drive interface, a magnetic disk drive-interface, and an optical drive interface, respectively. The drives and their associated computer-readable media provide nonvolatile storage of computer readable instructions, data structures, program modules and other data for the computer. These elements are typically included in most computer systems and the aforementioned system is intended to represent a broad category of systems supporting transmission, receipt and processing of messages.

The computer system may include fewer, different and/or additional elements, provided it is capable of performing processing steps in accordance with the present invention. Those skilled in the art will appreciate that the invention may be practiced with other computer system configurations, including hand-held devices, multi-processor systems, programmable equipment and machinery, minicomputers, mainframe computers, and the like. The invention may also be practiced in distributed computing environments where tasks are performed by remote processing devices that are linked through a communications network with program modules located in local and/or remote storage devices.

In a preferred implementation, each computer 100 and 120-140 operates in a networked environment using logical connections to one or more other computers. By way of example and not limitation, the network may be a local area network (LAN) and/or a wide area network (WAN), including the Internet, wireless or wired, a combination of any of the foregoing, or some other means of communicating computer readable data between separate computers. Such networking environments are commonplace.

Software for implementing a system and methodology in accordance with the present invention on the above-referenced computing environment may be stored on the server 100 and one or more of the client computers 120-140. The software may include an operating system, one or more application programs, other program modules, and program data. Firmware, application specific integrated circuits and other manifestations of computer processing instructions and data may be employed in lieu of or in addition to software without departing from the scope of the present invention.

As used herein, modules refer to system components configured to enable computer processing of instructions to achieve determined functionality. Modules may be comprised of software, such as programs, subprograms, libraries, functions or other software components, or combinations of any or all of the foregoing. Modules may also be comprised of hardware, firmware or other manifestations of computer processing instructions. A discrete component may perform multiple tasks, processes or functions and serve as a plurality of modules.

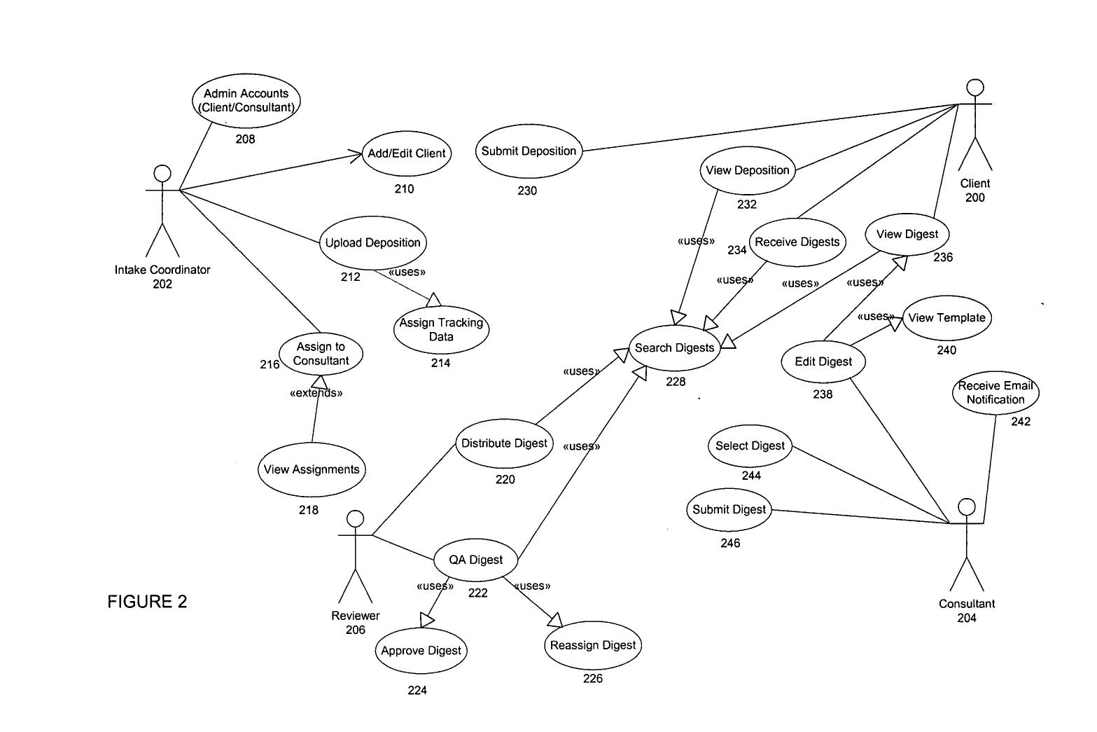

Referring now to FIG. 2, a use case diagram conceptually allocating responsibilities to various types of users in accordance with an exemplary embodiment of the present invention is shown. A preferred implementation of an exemplary implementation of the invention is configured for access and use by a plurality of users. By way of example and not limitation, the users may be classified into a plurality of categories including an intake coordinator 202, a client 200, a consultant 204 and a reviewer 206; though more or fewer users, with the same or different titles, and with different or combined roles and responsibilities, may have access to the system without departing from the scope of the present invention. Thus, for example, an intake coordinator 202 may also be a reviewer 206, and may be called an administrator or manager. Additionally, clients 200 may not have access to the system, or may only have indirect access through an intermediary such as a customer service representative or an intake coordinator 202. Furthermore, categories may include subcategories. Thus, an intake coordinator may be assigned different rights and privileges. For example, an intake coordinator may have the capability to add or delete other intake coordinators.

Illustratively, an intake coordinator 202 may manage digesting assignments and perform various administrative functions including administering accounts (e.g., client and consultant accounts) 208 and 210; uploading documents (e.g., depositions) 212 and assigning tracking data 214; and assigning digests to consultants 216. One or more intake coordinators may use the system.

A client (i.e., a user, not a computer) is the party who wishes to have summaries or digests created. There may be several clients and several client contacts for each client, and each client and each contact may request one or more digests. A client may be an individual or an entity, may be affiliated or associated with the party providing the summarization service, or may be an unrelated customer of the party providing the service. The client may have direct access to the system, e.g., via a network, or indirect access to the system through another user having direct access privileges. The client's functions include document submission 230, receiving and reviewing digests 234 and 236; searching and viewing uploaded documents and completed digests 228 and 236; and approving or establishing templates 240.

A consultant 204 may be responsible for creating and editing a digest from a document 238, which may entail receipt and acceptance of assignments 242, digest selection 244 for editing and submission of completed digests 246. One or more consultants may work on one or more digests.

A reviewer 206 may be responsible for quality control 222, including reviewing all completed deposition digests for accuracy and adherence to standards. The reviewer may approve 224, edit or reassign 226 digests. Once approved, a digest may be distributed to the client by the reviewer.

A client may submit documents in a native format to be summarized. If the client is a new client, the intake coordinator may add the client to the system. This format may include Microsoft Word, WordPerfect, Real Legal E-Transcript, or any other format readable by an intake coordinator. Submission can be via E-mail or hand delivery of storage media (CD, floppy disk, etc . . . ). An uploading module enables uploading of documents in an acceptable format to the system. Alternatively, printed documents may be hand delivered, which may then be optically scanned and converted to a determined format using an optical character recognition module. The intake coordinator will save the deposition in a determined format (e.g., HTML or XML format) before uploading it into the system. Alternatively, the system may be configured to automatically convert and save the documents in a determined format as an integral part of document uploading.

A login module governs user access to the system. A user id and password may be assigned to each authorized user. In a preferred implementation, a properly logged-in user is granted access to only those features and documents allowed or required for the type of user. For example, an intake coordinator may have access to all features and all documents, while a client may only have access to that client's documents and corresponding digests and status information.

Each time a user logs in marks the beginning of a session. A session for a user ends when that user logs out or the session is terminated, such as by timing out after a period of inactivity or by loss of network connectivity.

Prior to, or shortly after uploading a document, the intake coordinator and client may agree to the terms of the arrangement. Such terms may include pricing, delivery date and formats.

An assignment module allows an intake coordinator to assign and reassign tasks such as digest preparation and editing. In one implementation, the assignment module may require an intake coordinator to assign each document individually to a consultant. In another embodiment, the assignment module may allow an intake coordinator to assign a plurality of documents to a consultant at the same time. In yet another embodiment, the assignment module may automatically determine the consultants to whom documents should be assigned based on workload and/or productivity information or other quantitative or qualitative information concerning the consultant's availability, capacity, preferences or other indicia of suitability. Of course, the assignment module may further be configured to allow an intake coordinator to override default consultant assignments.

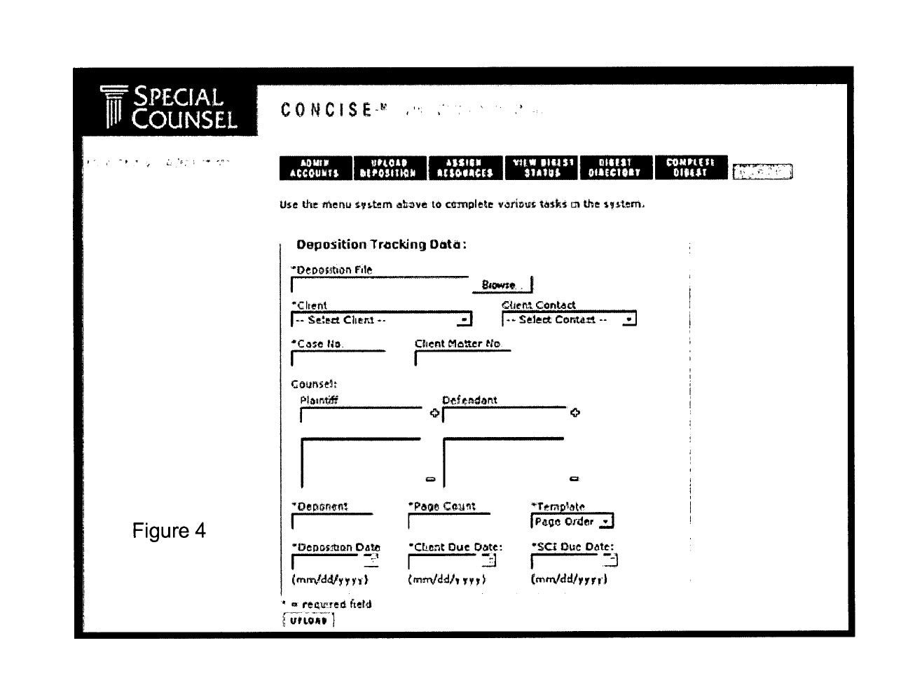

The assignment module may be configured to enable association of tracking data to a document that has been uploaded, for example, as conceptually illustrated in FIG. 4. By way of example, the tracking data may include a client name 420, a client matter number 426, a title 416, one or more dates 442-448, page information 438 and an assigned template identifier 440. Other information and user controls may also be provided. An intake coordinator may access the module and enter the desired data for a document. If any required information is missing or the data is entered in an improper format, a message may be displayed to alert the user.

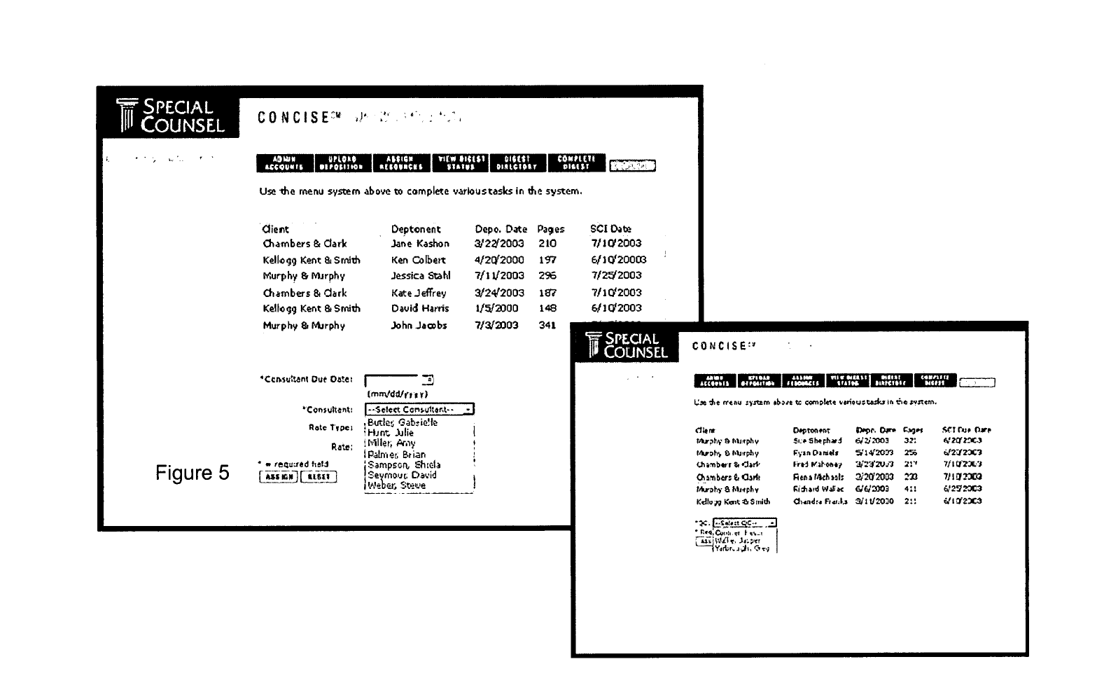

The assignment module may further be configured to enable an authorized user (e.g., an intake coordinator) to manage assignments of documents to consultants for creation of a summary or digest. Referring to FIG. 5, the module may display a list of unassigned or reassigned documents 504 along with other identifying indicia, such as client name 502. The status for a document may be unassigned or reassigned, either of which would require assignment to a consultant for preparation of a summary. Upon selecting a document, the user may select a consultant 516, enter a due date 512-514 for the consultant's summary, and optionally enter a pay rate for the service rendered by the consultant (not shown). The user may then instruct the module to assign the document, e.g., by selecting an “assign” icon 512, upon which the module will notify the consultant of the assignment, such as by sending a notification email to the consultant.

A document view module is configured to enable a user to search through a list of documents and select the document the user wishes to view. Preferably, only documents that a user is authorized to view are displayed in the list. Upon user selection of a document, the document is displayed on the user's display monitor in a determined format. The displayed document may be controlled, such as by panning, scrolling and zooming, and printing.

A notification module preferably generates and/or sends messages to users to notify them of status changes and tasks awaiting their attention. For example, a notification email that includes a hyperlink to another module or a page may be provided. Upon receiving an email notification and selecting the hyperlink, a module may be activated or a page displayed, allowing the user to take determined actions.

By way of example, the notification module may notify the intake coordinator of acceptance and rejection of assignments, such as by sending an email to the intake coordinator. The email may contain the lo pertinent assignment information and/or a link to the assignment module, which would preferably request proper login to access. The system thus enables users to conveniently manage assignments.

A digest selection module is configured to enable a consultant to prepare a new digest or edit an existing digest for an accepted assigned document. Upon successful login by a consultant, the module presents a list of all documents for which the consultant has accepted an assignment and digests need to be completed. Upon selecting a document, the system opens a digest. The digest may be an existing work in progress opened for editing or a new digest, as the case may be. As used herein, editing refers to amending and modifying an existing digest that is a work in progress, as well as to entering contents of a new digest.

In a preferred implementation, all editing is accomplished on-line using a digest editing module. The digest is preferably stored on a secure server. The consultant accesses the digest via network connectivity. A digest form or template may be provided to ensure that the format and content meet specifications. When a digest is opened for editing, the status associated with the digest is preferably changed to an in-progress status. As the digest is edited, the edited digest with all the additions, deletions and modifications may be saved on the server. The digest may be saved periodically and/or by consultant command. If a network connection is lost or a user logs out, or a session times out, the digest may be saved on the server. Optionally, for revision control, the system may maintain a separate copy of each version of a digest as of the end of each editing session. Alternatively, the system may maintain one or a determined plurality of prior versions of the digest from prior sessions. Thus, for example, both the current version and a version of the digest as of the end of a preceding session may be retained. The digest editing module may also provide sample digest entries to illustrate acceptable content, level of detail and format. Additionally, a user guide may be provided. Hyperlinks or other controls may provide a consultant to access the user guide and samples.

Other modules such as a spell checking module and/or grammar checking module may also be provided for spellchecking and grammar checking in a conventional manner. Examples of a suitable spell checking module include Spellex Corporation's Active X Speller, Apple+ for HTML Forms, ASP Spelling Server, CGI Speller, Java Software Development Kit (SDK), Source Code SDK and/or Windows SDK. Examples of suitable grammar checking software modules include WGrammar Grammar Checker Engine available by Wintertree Software. Such modules may be operably coupled to the digest editing module and other modules (e.g., the review module to enable spelling and grammar checking while editing a digest.

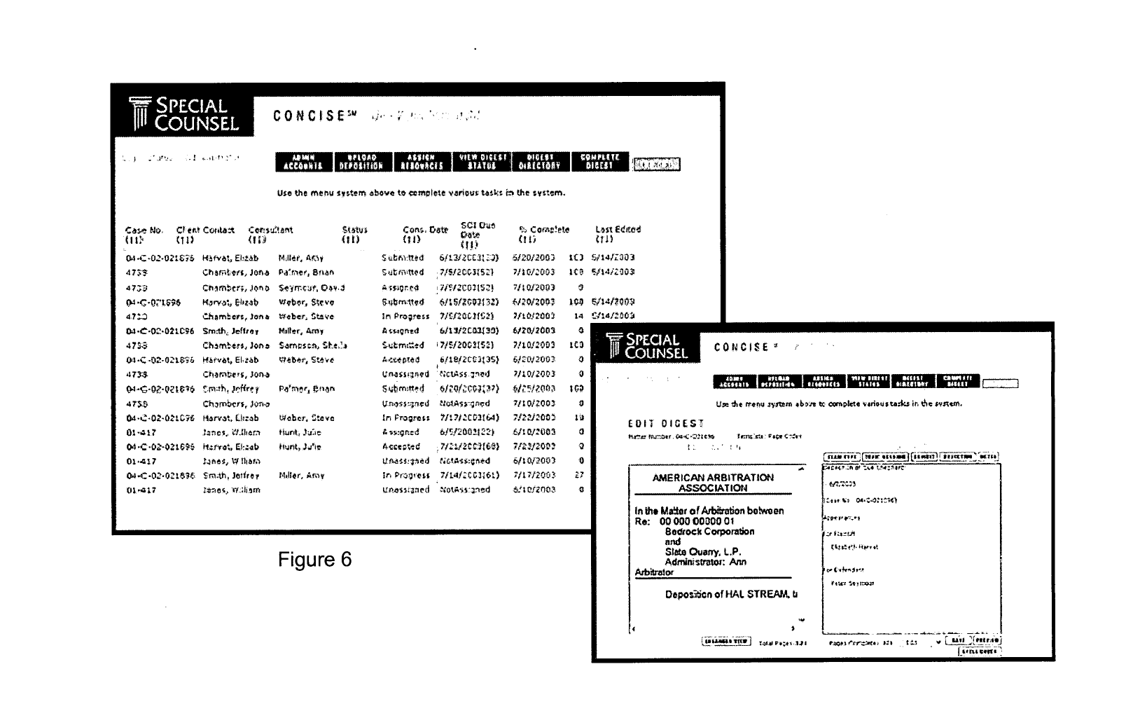

A status module may provide status summaries of uncompleted digests for all uploaded documents. Referring to FIG. 6, the module may display case, client and consultant information 602-606, a current status 608, various dates 610-612, a percentage completion 614, and a last edit date 606. As the system stores all work product on the server, an objective determination of percentage completion may be made automatically based on the extent of the digest and the corresponding section of the document. The percentage completion may be updated as work progresses. This provides a discreet means for accurately gauging progress.

A submission module is configured to enable a consultant to submit a completed digest to a user, such as a reviewer, for quality control. After an opened digest has been completed and saved, the consultant may enter a submit command, such as by selecting a submit icon, to submit the digest. The system then notifies the reviewer, such as by email, that a digest has been submitted for review. The reviewer may have been assigned by the intake coordinator, or determined by the system based on workload, productivity or other factors or methodologies. Alternatively, the system may notify all available reviewers, who may accept a review assignment on a first-come, first-serve basis.

Using a review module, a reviewer may accept, edit or reject a digest. As the reviewer reviews the submitted digest, the reviewer may make all necessary edits. The edits may be noted in the system and saved on the server. Upon reviewer approval, a digest is marked approved and made available for distribution. If the digest is not approved, the reviewer may annotate the reasons why the digest is not approved. The digest may then be passed back to the intake coordinator to be reassigned to either the same consultant or to another consultant.

A search module enables a user to search the system for existing digests and/or uploaded documents by entering search parameters. The parameters may include a matter number, a client name, a consultant name, dates and times, and/or a document name. Based on the search parameters, the system may return a linked list of all matching digests or documents, or a message.

A distribution module is configured to facilitate distribution of digests that are completed, submitted, approved and have been marked for distribution in the database. Distribution may be in the format agreed upon during the document submission. If email was selected, the digest may be e-mailed to the client automatically when it is distributed. Alternatively digests may be saved to and distributed on media, which would be sent to the client via an agreed to delivery method. As another option, a client with access to the system may select a digest from a search page and select download.

An exemplary system in accordance with the present invention may be comprised of the foregoing modules. Additional modules may also be provided. Additionally, modules may be integrated, combined or streamlined without departing from the scope of the present invention.

### Methodology of the Invention

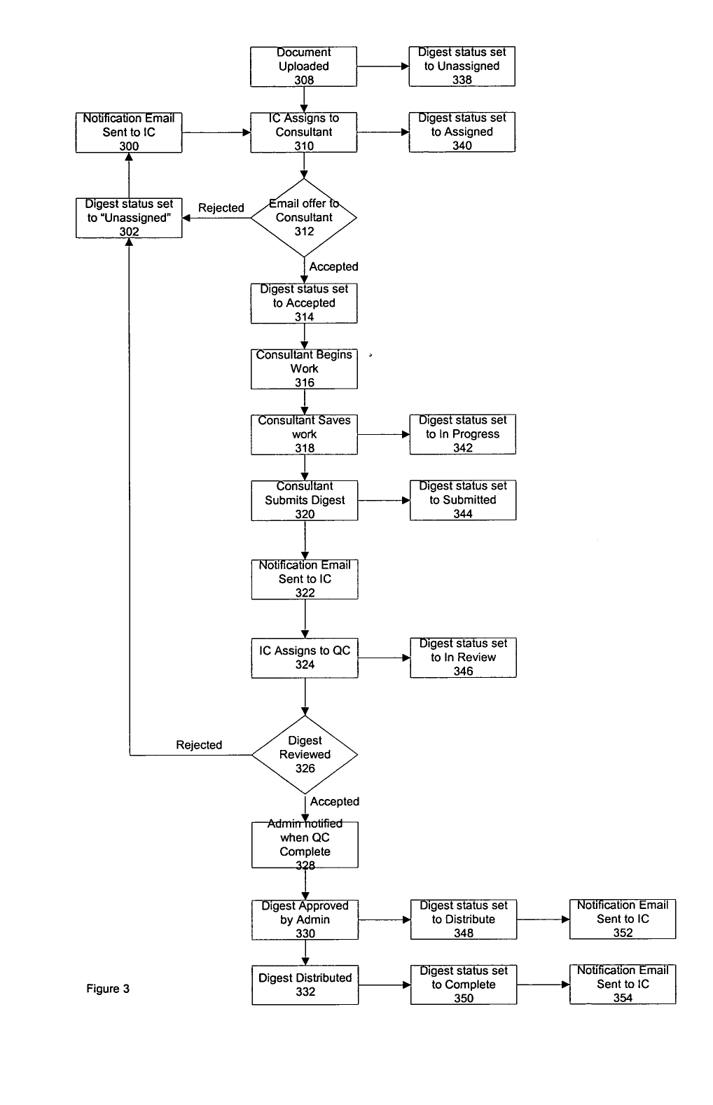

FIG. 3 is a flow diagram illustrating steps of a methodology in accordance with an exemplary implementation of the invention. FIG. 3 may equally represent a high level block diagram of the system of the invention. The steps of FIG. 3 may be implemented on computer program code in combination with appropriate hardware. This computer program code may be stored on storage media such as a diskette, hard disk, CD-ROM, DVD-ROM or tape, as well as a memory storage device or collection of memory storage devices such as read-only memory (ROM) or random access memory (RAM). Additionally, the computer program code can be transferred to a workstation over the Internet or some other type of network.

Uploading a document as in step 308 entails saving a document in a desired format on the system. The document may be provided in the desired format or converted to the desired format. The conversion may be automatic, semi-automatic or manual.

Upon uploading, a digest status is set to unassigned as in step 338. The digest status will change as steps of the process are completed.

After uploading, an intake coordinator assigns the digest to a consultant as in step 310. The consultant may be determined by the intake coordinator, someone else (e.g., the client) or by an automated process. Upon assignment, the digest status is set to assigned as in step 340.

Upon assignment, a message (e.g., an email message) is sent to the consultant to inform the consultant of the new assignment, as in step 312. The consultant will then have an opportunity to accept or reject the assignment. If rejected, the digest status is reset to unassigned as in step 302 and the intake coordinator is notified as in step 300. If accepted, the digest status is set to accepted, as in step 314.

The consultant may then commence work on the assigned digest as in step 316. The digesting (summarization) effort may take several sessions. One or more times during each session, the consultant may save the work product. The saved work product is preferably securely stored on the system's server. While the work is in progress, the digest status is set to in progress, as in step 342.

Upon completion of an initial draft digest, the consultant may submit it for review as in step 320. Upon submission, the digest status is changed to submitted 344.

The system may then notify an intake coordinator (or a reviewer) that the digest is ready for review as in step 322. The intake coordinator may then assign the reviewing task to a reviewer, as in step 324.

Of course, the process may further include steps (not shown) for a reviewer to accept or reject an assigned reviewing task. If a reviewer rejects an assigned reviewing task, the digest status may be reset to submitted and the intake coordinator may be notified. If accepted, the digest status may be set to “in review,” as in step 346.

Upon review, a reviewer may accept a digest without editing, edit a digest and accept it as edited, or reject a digest, as in step 326. Preferably, a rejected digest is annotated by the reviewer with explanations for the rejection to facilitate correction. Upon rejection, the digest status may be reset to unassigned and a notification message (e.g., an email) may be provided to alert the intake coordinator as in steps 302 and 300. The intake coordinator may then reassign the digest to the same or another consultant. Alternatively, the system may automatically reassign the rejected digest to the same consultant or another consultant based upon availability. Of course, the consultant may have an opportunity to accept or decline the assignment, as in step 312.

Upon acceptance of a digest, marking completion of quality control, an administrator, such as an intake coordinator or another user with administrative or management responsibilities, may be notified as in step 328. The administrator may then have an opportunity to review the digest as in step 330.

Assuming the review reveals no further issues, the digest may be approved for distribution as in step 348, whereupon the intake coordinator may be notified of the new status as in step 352. Then the digest may be distributed in a determined format (e.g., in printed format, stored on media, or electronically via email), or made available for downloading (e.g., ftp) by a client, as in step 332. Upon delivery the digest status is set to complete, whereupon the intake coordinator may be notified, as in steps 350 and 354.

The flowchart conceptually illustrates an exemplary methodology. Those skilled in the art will appreciate that additional steps, such as steps affording the client an opportunity to review and accept or reject a delivered digest, may also be provided without departing from the scope of the present invention. Additionally, steps may be combined, certain steps may be omitted and the order of certain steps may be switched without departing from the scope of the present invention.

While the invention has been described in terms of various embodiments and implementations, those skilled in the art will recognize that the invention can be practiced with modification within the spirit and scope of the appended claims.

1. A computer implemented document digest system comprised of:
a first module configured to enable a user to assign a document to a consultant for creating a digest;
a second module configured to enable the consultant to access, create and edit the digest; and
a third module configured to enable a reviewer to review the digest created by the consultant.

2. The system of claim 1, further comprising a login module configured to control access to the system by the user, consultant and reviewer.

3. The system of claim 1, further comprising a fourth module configured to monitor the status of a digest.

4. The system of claim 1, further comprising a fifth module configured to enable uploading of the document to the system.

5. The system of claim 1, further comprising a sixth module configured to enable distribution of the digest upon completion.

6. The system of claim 1, wherein the first module is further configured to associate tracking data with the digest.

7. The system of claim 1, wherein the first module is further configured to provide a list of available consultants from which the consultant may be selected.

8. The system of claim 1, wherein the second module is further configured to enable the consultant to submit the digest for review by the reviewer.

9. The system of claim 1, wherein the third module is further configured to enable a reviewer to approve, edit and reassign the digest created by the consultant.

10. The system of claim 1, further comprising
a login module configured to control access to the system by the user, consultant and reviewer;
a fourth module configured to monitor the status of a digest;
a fifth module configured to enable uploading of the document to the system; and
a sixth module configured to enable distribution of the digest upon completion;
wherein the first module is further configured to associate tracking data with the digest and to provide a list of available consultants from which the consultant may be selected;
the second module is further configured to enable the consultant to submit the digest for review by the reviewer; and
the third module is further configured to enable a reviewer to approve, edit and reassign the digest created by the consultant.

11. A computer implemented document digest process comprised of steps of:
assigning a document to a consultant for creating a digest and notifying the consultant of the assignment via network communications;
enabling the consultant to access, create and edit the digest for the document;
notifying a reviewer of the digest created by the consultant; and
enabling the reviewer to review the digest created by the consultant.

12. The process of claim 11, further comprising a step of controlling access to the system by the user, consultant and reviewer using a login.

13. The process of claim 11, further comprising a step of monitoring the status of a digest.

14. The process of claim 11, further comprising a step of uploading the document.

15. The process of claim 11, further comprising a step of enabling distribution of the digest upon completion.

16. The process of claim 11, wherein the step of assigning a document includes associating tracking data with the digest.

17. The process of claim 11, wherein the step of assigning a document includes selecting the consultant from a list of available consultants.

18. The process of claim 11, wherein the step of enabling the consultant to access, create and edit the digest for the document includes a step of enabling submission of the digest for review by the reviewer.

19. The process of claim 11, wherein the step of enabling a reviewer to review the digest further includes a step of enabling a reviewer to approve, edit and reassign the digest created by the consultant.

20. The process of claim 11, further comprising steps of controlling access to the system by the user, consultant and reviewer using a login;
monitoring the status of a digest;
uploading the document;
enabling distribution of the digest upon completion;
wherein the step of assigning a document includes associating tracking data with the digest; and
the step of assigning a document includes selecting the consultant from a list of available consultants; and
the step of enabling the consultant to access, create and edit the digest for the document includes a step of enabling submission of the digest for review by the reviewer; and
the step of enabling a reviewer to review the digest further includes a step of enabling a reviewer to approve, edit and reassign the digest created by the consultant.
